(19) United States
(12) Patent Application Publication
(10) Pub. No.: US 2025/0315292 A1
(43) Pub. Date: Oct. 9, 2025

(54) METHOD FOR STARTING A USER INTERFACE COMPONENT, APPARAUTS, DEVICE, AND MEDIUM

(71) Applicant: Beijing Zitiao Network Technology Co., Ltd., Beijing (CN)

(72) Inventor: Zeqing Xie, Beijing (CN)

(21) Appl. No.: 19/170,005

(22) Filed: Apr. 3, 2025

(30) Foreign Application Priority Data
Apr. 7, 2024 (CN) 202410411227.9

(51) Int. Cl. G06F 9/48; G06F 9/451

(52) U.S. Cl. CPC G06F 9/485; G06F 9/451; G06F 2209/482

(57) ABSTRACT

The embodiment of the disclosure provides a user interface component starting method and device, equipment and a medium. One specific embodiment of the method includes the following steps: in response to starting of a target application, executing a first part of a startup task of a target application, and after execution of the first part is completed, starting a first user interface component through a main process corresponding to the target program; in the starting process of the first user interface component, executing a second part of a startup task of the target application through the main process, and starting a second user interface component through the sub-process of the main process, and overlaying the second user interface component on the first user interface component.

### CROSS-REFERENCE

This application claims priority to Chinese patent application No. 202410411227.9, entitled “METHOD FOR STARTING A USER INTERFACE COMPONENT, APPARAUTS, DEVICE, AND MEDIUM” filed on Apr. 7, 2024, the entire contents of which are incorporated herein by reference.

### FIELD

Embodiments in the disclosure relate to the technical field of code cleaning, in particular to method for starting a user interface component, apparatus, device, and a medium.

### BACKGROUND

Application Not Responding (ANR) indicates that an application fails to respond to user input or system operation for a period of time. For example, when an application is started and a user inputs via a click or a touch event, the event input by the user cannot be received or responded as the interface window corresponding to the user interface component of the application has not been built. If the event input by the user is not responded within a specific time interval, an application error may occur, resulting in poor user experience. Therefore, there is a need for a new method for starting a user interface component.

### SUMMARY

The embodiment of the disclosure discloses a user interface component starting method and device, equipment and a medium.

According to a first aspect, a method for starting a user interface component is provided, including:
executing a first part of a startup task of a target application in response to a start of the target application, and starting a first user interface component through a main process corresponding to the target application after execution of the first part is completed:
during a start process of the first user interface component, executing a second part of the startup task of the target application through the main process, and starting a second user interface component through a child process of the main process, the second user interface component overlaying the first user interface component.

According to a second aspect, an apparatus for starting a user interface component is provided, including:
a starting module, configured to execute a first part of a startup task of a target application in response to a start of the target application, and start a first user interface component through a main process corresponding to the target application after execution of the first part is completed:
an overlaying module, configured to, during a start process of the first user interface component, execute a second part of the startup task of the target application through the main process, and start a second user interface component through a child process of the main process, the second user interface component overlaying the first user interface component and is configured to be in a transparent state.

According to a third aspect, a computer-readable storage medium is provided, where a computer program is stored, and when the computer program is executed in a computer, the computer is enabled to perform the method according to the first aspect.

According to a fourth aspect, an electronic device is provided, including a memory and a processor, where the memory stores executable code, and when the processor executes the executable code, the method in the first aspect is implemented.

According to the embodiments in the disclosure, a method for starting a user interface component, apparatus, device and medium are provided. First, a first part of a startup task of a target application may be executed in response to a start of the target application, and after execution of the first part is completed, a first user interface component is started by the main process corresponding to the target program. During the start process of the first user interface component, a second part of the startup task of the target application may be executed through the main process, and a second user interface component may be started through a child process of the main process, and the second user interface component may cover the first user interface component. With the method, the time for application start to respond to user input events may be greatly shortened, reducing the probability of users encountering unresponsive applications.

### BRIEF DESCRIPTION OF DRAWINGS

FIG. 1 shows a schematic diagram of a start of an application;

FIG. 2 is a schematic diagram of a method for starting a user interface component according to an embodiment of the present disclosure:

FIG. 3 is a schematic flowchart of a method for starting a user interface component according to an embodiment of the present disclosure:

FIG. 4 shows a schematic diagram of responding to a user input event according to an embodiment of the present disclosure:

FIG. 5 illustrates a schematic diagram of destroying a second user interface component according to an embodiment of the present disclosure:

FIG. 6 shows a schematic diagram of destroying a second user interface component according to another embodiment of the present disclosure:

FIG. 7 shows a schematic block diagram of an apparatus for starting a user interface component according to an embodiment of the present disclosure:

FIG. 8 shows a schematic structural diagram of an electronic device suitable for implementing an embodiment of the present disclosure:

FIG. 9 shows a schematic structural diagram of a storage medium suitable for implementing the embodiments of the present disclosure.

### DETAILED DESCRIPTION

The technical solutions provided in this specification are further described in detail below with reference to the accompanying drawings and embodiments. It is to be understood that the specific embodiments described herein are merely for explaining the relevant disclosure, rather than limiting the disclosure. In addition, it should be noted that, for case of description, only parts related to the present disclosure are shown in the accompanying drawings. It should be noted that, in the case of no conflict, the features in the embodiments and embodiments of the present disclosure may be combined with each other.

In the description of implementations of the present disclosure, the terms “include”, and similar terms should be understood to include “including but not limited to”. The term “based on” should be understood as “based at least in part on”. The terms “one/seed implementation” or “the implementation” should be understood as “at least one implementation”. The term “some implementations” should be understood as “at least some implementations”. Other explicit and implicit definitions may also be included below:

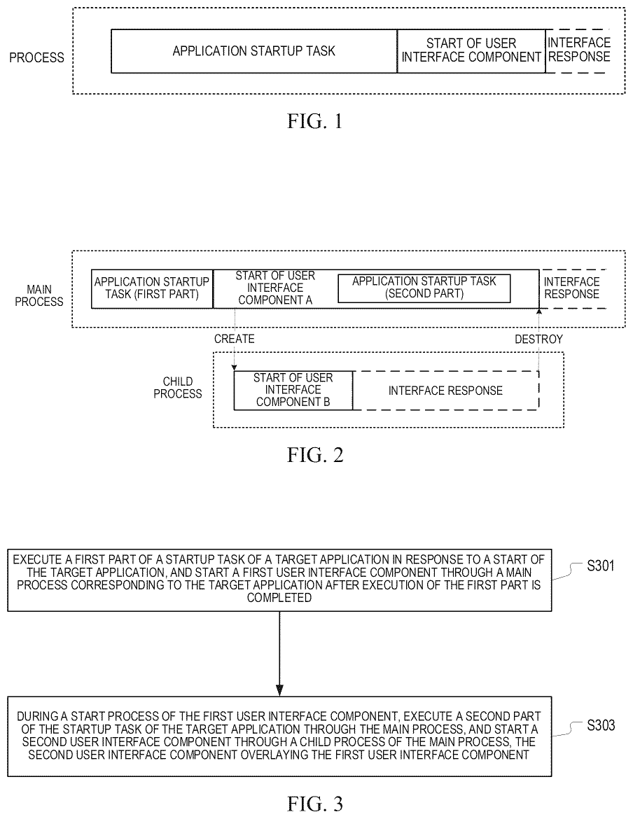

As described above, an Application Not Responding (ANR) is applied to indicate that an application fails to respond to user input or system operation within a period of time. For example, when an application is started and a user inputs via a click or a touch event, the event input by the user cannot be received or responded as the interface window corresponding to the user interface component of the application has not been built. If the event input by the user is not responded within a specific time interval, an application error may occur, resulting in poor user experience. For example. FIG. 1 is a schematic diagram of a start of an application. As shown in FIG. 1, after the application is started, a startup task of the application is executed through the main process of the application. After the execution of the startup task is completed, a user interface component of the application may be generally launched. And after the startup of the user interface component is completed, an input event from the user, such as an event the user touching the screen or clicking on the screen, may be received and responded to by the application interface component. However, the problem in this solution lies in that, on one hand, as user input events are usually responded to after the application start process and the user interface start process are completed, there is no the user interface component to respond to a user input event for a long time if the application start process is relatively long, which leads to the long period during which no feedback is received by the user, resulting in a degraded user experience. On the other hand, if the event input by the user is not received after a certain time, it often leads to more serious system security problems, such as a system crash, which not only further degrades the user experience, but also affects the normal operation of the application.

An existing technical solution to reduce the occurrence of unresponsiveness of such applications mainly reduces execution time of the application start process by reducing execution content in the application startup task, thus the likelihood of the occurrence of an unresponsiveness is reduced. However, the problem of this solution is that the application start process often includes the initialization of the application code itself, of the application service data, of the invoke of the application SDK (Software Development Kit), and the like. The initialization of the application code itself is usually difficult to compress. For example, the compress of the initialization of the service data, the SDK, etc. often prevents the application from its normal service functions. Another existing technical solution to reduce the occurrence of unresponsiveness of such applications is mainly through software debugging (Debug), which tracks a specific user input event causing a system crash and determine a targeted event handler based on the specific user input event, so as to reduce application crash. However, the problem of this solution is that software debugging needs to consume manpower and can only address individual applications in a targeted manner. The overall start time of the application cannot be fundamentally reduced, hence the possibility of the unresponsiveness of the application.

In order to solve the above technical problem, embodiments in the present disclosure provide a method for starting a user interface component. FIG. 2 is a schematic diagram of a method for starting a user interface component according to an embodiment of the present disclosure. As shown in FIG. 2, in some embodiments, a startup task of a target application may be divided into two parts, for example, a first part and a second part. When the target application is started, the main process of the target application executes the first part of the startup task. After the execution of the first part is completed, a user interface component (for example, the user interface component A) of the application is started through the main process. In a start process of the user interface component A, a second part of the application startup task is executed, and another user interface component (for example, a user interface component B) configured to be transparent is started by the child process of the main process, and the user interface component B overlays the user interface component A.

The method is with the advantages that on one hand, the startup task of the application is divided into two parts in advance, and the second part of the application is executed in a user interface component (for example, the user interface component A in FIG. 2) using the main process, and another user interface component (or referred to as a placeholder user interface component, such as the user interface component B in FIG. 2) overlaying on the user interface component is run by using the sub-process, and the user input time is received through the second user interface component, so that the time for starting and responding to the user input event from the application can be greatly shortened, and the probability that the user encounters an application unresponsiveness is reduced. In the second aspect, according to the method, a conventional application starting solution is modified, except that in the starting process of the user interface component, another user interface component overlaying the user interface component is started by the child process, and only the startup task of the target application needs to be divided into two parts, and the execution of one part is moved to the starting process of the first started user interface component. In other words, the service function of the conventional application starting scheme can be completely achieved on the basis of the conventional application starting scheme, and the starting scheme of the user interface component with no response to the application can be greatly reduced.

A detailed process of the method is further described below.

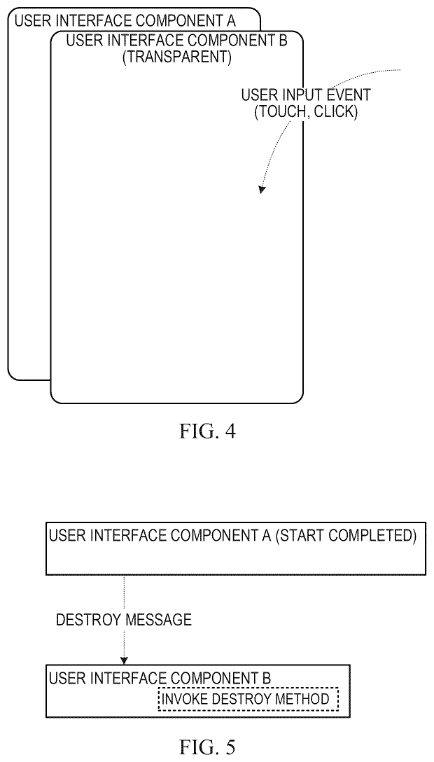

FIG. 3 is a schematic flowchart of a method for starting a user interface component according to an embodiment of the present disclosure. As shown in FIG. 4, the method includes at least the following steps:

Step S401, in response to a startup of a target application, executing a first part of a startup task of a target application, and after execution of the first part is completed, starting a first user interface component through a main process corresponding to the target program:

Step S403, in a start process of the first user interface component, executing a second part of a startup task of a target application through the main process, and starting a second user interface component through a child process of the main process, where the second user interface component overlays the first user interface component.

First, in step S401, in response to the starting of the target application, a first part of the startup task of the target application is executed, and after execution of the first part is completed, the first user interface component is started by the main process corresponding to the target program. In this step, the first part of the startup task may be executed after the target application is started. In different embodiments, the target application may be an application for different specific services or purposes, which is not limited in this specification. The launching task of the target application includes a plurality of sub-tasks that are typically executed during a launching process of the target application. In different embodiments, according to different target applications, specific sub-tasks included in the startup task of the target application may also be different, which is not limited in this specification. These subtasks may be pre-divided into two parts (namely, two parts of a startup task), for example, a first part and a second part. Therefore, the child task included in the first part may be executed by the master process of the target program after the target application is started. A main process is a process that starts running first after the application or program is started, and is responsible for coordinating and managing the overall running process of the management application. The main process is usually responsible for loading the initialization code of the application, and may be used to start another process of the application, or process a main task of the application.

In different embodiments, the specific manner of pre-dividing the startup task may be different. Specifically, in an embodiment, the first part of the startup task includes an initialization (or referred to as an application code initialization sub task) of executing code included in the target application itself. In an embodiment, the second part of the startup task may include one or more of an initialization (or referred to as an SDK initialization sub-task) of a software development kit (SDK) that executes the code invocation, an initialization (or referred to as an invoking component initialization sub-task) of another component that executes the code invocation, or a service data initialization (or referred to as a service data initialization sub-task) corresponding to the target application. Due to the initialization of the execution code included in the target application itself, it is usually the premise of executing other promoter tasks or starting user interface components. Therefore, the application code initialization subtask is divided into the first part and executed after the application is started, so that the time for executing the startup task before the user interface component is started can be reduced. In addition, the first user interface component can be successfully started after execution of the first part is completed, and other sub-tasks of starting the task can be smoothly executed after the user interface component is started in subsequent steps.

After execution of the first part is completed, the first user interface component may be started by the main process of the target program. A user interface component is a component for providing a user interface and enabling user interaction. In different embodiments, the specific types of the first user interface components may be different. In one example, for example, an Activity component may be used.

Then, in step S403, the second part of the startup task of the target application may be executed by the main process in the start process of the first user interface component, and the second user interface component may be started through the child process of the main process, and the second user interface component may be overlaid on the first user interface component. In this step, after the first user interface component is started, the second part of the startup task of the application program may be executed through the main process in the start process of the first user interface component. In other words, the second part of the startup task of the application may be embedded in the start process of the first user interface component.

A child process refers to a process created by another process (corresponding to a parent process). In the starting process of the first user interface component, the second user interface component may also be started through the child process created by the main process, and the second user interface component may be overlaid on the first user interface component. Because the sub-task of the application launching task is not executed in the launching of the second user interface component, the launching speed of the second user interface component is significantly faster relative to the first user interface component. The second user interface component overlaid on the first user interface component may replace the first user interface component in response to the user input event before the first user interface component initiates completion. In addition, since the child processes have independence, execution of the child processes, even crash or error, typically does not affect the execution of other processes. For example, a running error of a child thread has a possibility of causing a crash of the main process. Moreover, the operation of sub-threads, especially for complex applications, often requires complex synchronization and coordination with other threads of the main thread. Therefore, starting the second user interface component by the child process, starting the second user interface component relative to, for example, the child thread passing through the main process, achieves lower cost and better security for application running.

In a specific example, the second user interface may also be a user interface component having only a base response function of the base class of the user interface component. Therefore, the starting speed of the second user interface component is further accelerated, the response time for the user input event is shortened, and the user experience is improved.

In different embodiments, the start process of the first user interface component may include a plurality of different specific stages. In an embodiment, the start process of the first user interface component may include: a creation stage corresponding to the first user interface component, or referred to as an OnCreate stage. Further, the second part of the startup task of the target application may be executed by the main process at the creation stage. In an embodiment, the second part of the startup task of the target application may also be executed by using the child process of the master process in the creation stage. An OnCreate stage is one stage in the lifecycle of a user interface component including, for example, Activity. Operations desired to be performed at this stage may be performed at this stage by invoking a corresponding callback function. Therefore, in the foregoing manner, the second part of the startup task can be conveniently embedded in the creation stage, and the child process of the main process is created, and the operation of the second user interface component is started through the child process. In addition, since, for example, the interface drawing of the user interface component is often at the creation stage, the above method may be performed before the interface drawing of the first user interface component, thereby further improving the user experience.

In different embodiments, for example, a specific interface content may be displayed during startup of the first user interface. In order to prevent the problem that the user cannot see the content that can be displayed by the first user interface, in an embodiment, the second user interface component may also be configured to be in a transparent state. In this way, the second user interface does not block the content of the first user interface, thereby preventing the user from seeing the problem of valuable content displayed in the starting process of the first user interface. FIG. 4 shows a schematic diagram of responding to a user input event according to an embodiment of the present disclosure, for example, the user interface component B (that is, the second user interface) may be overlaid on the user interface component A (that is, the first user interface), so that the user input event may be received through the user interface component B before the start process of the user interface component A is not completed. The user interface component B may be set transparent so as not to block the display content of the first user interface component.

In an embodiment, after step S403, the user input event may also be responded to by using the second user interface component. In different embodiments, the user input events received through the second user interface component may be different. In a specific embodiment, for example, one or more of a touch event and a click event may be included. In a specific example, the click event may include, for example, a click event for the interface or a click event for a default Back button on the interface. Because the second part of the startup task of the application is embedded in the start process of the first user interface component, the execution time of the process is longer than that of the general user interface component. In the foregoing manner, before the first user interface component is started, the second user interface component responds to the user input event. Therefore, on one hand, the waiting time of the user is reduced, and the user experience is improved. On the other hand, it is also possible to avoid, for example, an application crash problem caused because the user input time is not responded to a long time.

Since the user input event has been responded to by the first user interface component itself after the starting process of the first user interface component is completed. Therefore, in an embodiment, after step S403, the second user interface component may be destroyed after the start process of the first user interface component is completed. As shown in FIG. 5, in a specific embodiment, destroying the second user interface component may include: after the start process is completed, the first user interface component (for example, the user interface component A) may send, to the second user interface component (for example, the user interface component B), that the start process of the first user interface component is completed, so that the message (for example, the first message) of the second user interface component may be destroyed; and after receiving the first message, the second user interface component triggers the destruction process of the second user interface component by invoking a predetermined destruction method. In a specific embodiment, the first user interface component sends a message to the second user interface component, for example, may be performed through a broadcast between the main process and the child process. In this way, the second user interface component can be conveniently destroyed after the start process of the first user interface component is completed.

In some scenarios, the user not only triggers the input event in the starting process of the first user interface component, but also can input information such as text information, for example. As shown in FIG. 6, in another specific embodiment, before the second user interface component (for example, the user interface component B) triggers the destruction process of the second user interface component by invoking the predetermined destruction method, the second user interface component (for example, the user interface component A) sends the user input information received by the second user interface component (after it is started). In this way: the user input information can be processed through the started first user interface component to prevent the information input by the user from being missed.

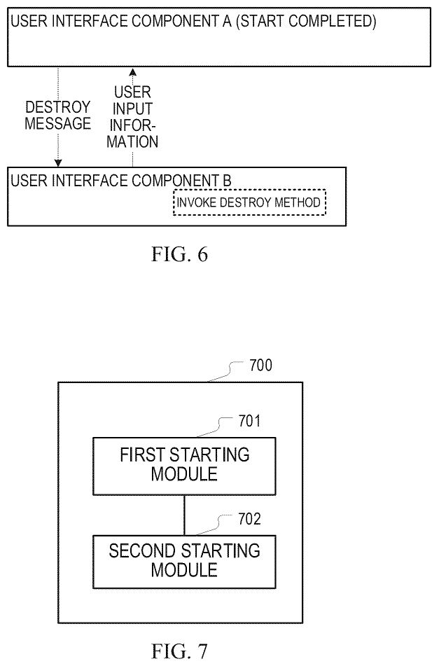

FIG. 7 shows a schematic block diagram of an apparatus for starting a user interface component according to an embodiment of the present disclosure. The apparatus is configured to perform the method shown in FIG. 3. As shown in FIG. 7, the apparatus 700 includes:

A first starting unit 701, configured to, in response to a start of a target application, execute a first part of a startup task of a target application, and after execution of the first part is completed, start a first user interface component through a main process corresponding to the target program:

The second starting unit 702 is configured to, during a start process of the first user interface component, execute a second part of a startup task of a target application through the main process, and start a second user interface component through a child process of the main process, where the second user interface component overlays the first user interface component and is configured to be in a transparent state.

An embodiment of the present disclosure further provides an electronic device, including a memory and a processor, where the memory stores executable code, and when the processor executes the executable code, the method shown in FIG. 3 is implemented.

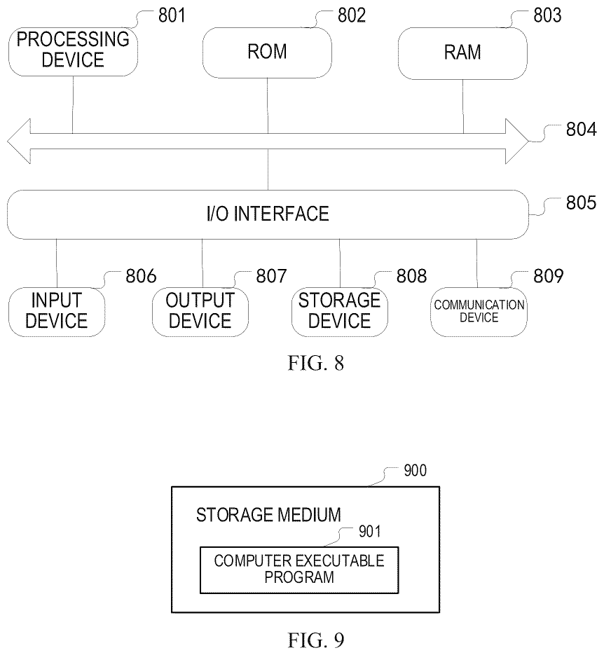

FIG. 8 is a schematic structural diagram of an electronic device 800 suitable for implementing an embodiment of this application. The electronic device 800 shown in FIG. 8 is merely an example, and should not impose any limitation on the functions and the use scope of the embodiments of this application.

As shown in FIG. 8, the electronic device 800 may include a processing device (for example, a central processing unit, a graphics processor, etc.) 801. The processing device 801 may be a general-purpose processor, a digital signal processor (DSP), a microprocessor, or a microcontroller, or may further include an application specific integrated circuit (ASIC), a field-programmable gate array (FPGA) or another programmable logic device, a discrete gate or transistor logic device, or a discrete hardware component, and may perform various appropriate actions and processing according to a program stored in a read-only memory (ROM) 802 or a program loaded into a random access memory (RAM) 803 from a storage device 808. In RAM803, various programs and data required by the operation of the electronic device 800 are also stored. The processing devices 801, ROM802 and RAM803 are connected to each other via a bus 804. Input/output (I/O) interface 805 is also connected to bus 804.

Generally, the following devices may be connected to the I/O interface 805: an input device 806 including, for example, a touch screen, a touch pad, a keyboard, a mouse, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided. Each block shown in FIG. 8 may represent one apparatus, or may represent multiple apparatuses as required.

In particular, according to an embodiment of the present application, the process described above with reference to the flowchart may be implemented as a computer software program. For example, embodiments of the present disclosure include a computer program product including a computer program embodied on a computer-readable medium, the computer program including program code for performing the method shown in the flowchart. In such embodiments, the computer program may be downloaded and installed from the network through the communication device 809, or installed from the storage device 808, or installed from ROM802. When the computer program is executed by the processing apparatus 801, the foregoing functions defined in the method for starting a user interface component provided in this embodiment of this application are performed.

An embodiment of the present disclosure further provides a computer-readable storage medium having a computer program stored thereon, and when the computer program is executed in a computer, the computer is enabled to perform the method for starting a user interface component as shown in FIG. 4 according to an embodiment of this application. FIG. 9 is a schematic diagram of a storage medium according to an embodiment of this application. For example, as shown in FIG. 9, the storage medium 900 may be a non-transitory computer-readable storage medium for storing non-transitory computer-executable instructions 901. When the non-transitory computer executable instruction 901 is executed by the processor, the startup method of the user interface component provided in this embodiment of this application may be implemented, for example, when the non-transitory computer executable instruction 901 is executed by the processor, one or more steps in the startup method of the user interface component provided in the embodiments of this application may be performed. For example, the storage medium 900 may be applied to the foregoing electronic device, for example, the storage medium 900 may include a memory in the electronic device. For description of the storage medium 900, reference may be made to the description of the memory in the embodiment of the electronic device, and details are not described herein again. For specific functions and technical effects of the storage medium 900, refer to the description of the startup method of the user interface component provided in the embodiments of this application, and details are not described herein again.

It should be noted that the computer-readable medium of the embodiments of the present disclosure may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a memory card of a smartphone, a storage component of a tablet, a portable computer diskette, a hard disk of a personal computer, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In embodiments of the present disclosure, a computer-readable storage medium may be any tangible medium containing or storing a program that may be used by or in connection with an instruction execution system, apparatus, or device. In an embodiment of the present disclosure, the computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables. Radio Frequency (RF), and the like, or any suitable combination thereof.

The computer-readable medium described above may be included in the electronic device: or may be separately present without being assembled into the electronic device. The computer-readable medium carries one or more programs, and when the one or more programs are executed by the server, the electronic device is enabled to implement the method for starting a user interface component provided in the embodiments of this application.

Computer program code for carrying out the operations of embodiments of the present disclosure may be written in one or more programming languages or combinations thereof, including an object oriented programming language such as Java. Smalltalk. C++, and also conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions. The units involved in the embodiments of the present disclosure may be implemented in software, or may be implemented in hardware. The name of the unit does not constitute a limitation on the unit itself in some cases. The functions described above may be performed, at least in part, by one or more hardware logic components. For example, without limitation, example types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

Various embodiments in this specification are described in a progressive manner, and parts that are the same and similar between the embodiments may be referred to each other, and each embodiment focuses on differences from other embodiments. In particular, for the storage medium and the computing device embodiment, since it is substantially similar to the method embodiment, the description is relatively simple, and reference may be made to some descriptions of the method embodiments at the relevant parts.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to). Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

The objects, technical solutions and beneficial effects of the embodiments of the present disclosure are further described in detail above with reference to specific embodiments. Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims. It should be understood that the above is only a specific embodiment of the embodiments of the present disclosure, and is not intended to limit the protection scope of the present disclosure, and any modification, equivalent substitution, improvement and the like made on the basis of the technical solutions of the present disclosure should be included within the protection scope of the present disclosure.

I/We claim:

1. A method for starting a user interface component, comprising:
executing a first part of a startup task of a target application in response to a start of the target application, and starting a first user interface component through a main process corresponding to the target application after execution of the first part is completed:
during a start process of the first user interface component, executing a second part of the startup task of the target application through the main process, and starting a second user interface component through a child process of the main process, the second user interface component overlaying the first user interface component.

2. The method of claim 1, wherein the start process of the first user interface component comprises: a creation stage corresponding to the first user interface component:
during the start process of the first user interface component, executing the second part of the startup task of the target application through the main process comprises: executing the second part of the startup task of the target application through the main process in the creation stage:
starting the second user interface component through the child process of the main process comprises: starting the second user interface component through the child process of the main process in the creation stage.

3. The method of claim 1, wherein the second user interface component is configured to be in a transparent state.

4. The method of claim 1, further comprising: responding to a user input event through the second user interface component.

5. The method of claim 4, wherein the user input event comprises one or more of: a touch event or a click event.

6. The method of claim 1, further comprising: after the start process of the first user interface component is completed, destroying the second user interface component.

7. The method of claim 6, wherein destroying the second user interface component is by way of:
after the start process is completed, sending, by the first user interface component to the second user interface component, a first message indicating that the start process of the first user interface component is completed:
after receiving the first message, triggering, by the second user interface component, the destruction process of the second user interface component by invoking a predetermined destruction method.

8. The method of claim 7, further comprising:
before triggering the destruction process of the second user interface component by invoking the predetermined destruction method, sending, by the second user interface component to the first user interface component, user input information received by the second user interface component.

9. The method of claim 1, wherein the first part of the startup task comprises initialization of the execution code comprised in the target application.

10. The method of claim 9, wherein the second part of the startup task comprises one or more of: initialization of a software development kit invoked by the execution code, initialization of a further component invoked by the execution code, or initialization of service data corresponding to the target application.

11. An electronic device, comprising:
a memory and a processor, wherein the memory stores executable code, and the processor executes the executable code to implement a method starting a user interface component, comprising:
executing a first part of a startup task of a target application in response to a start of the target application, and starting a first user interface component through a main process corresponding to the target application after execution of the first part is completed:
during a start process of the first user interface component, executing a second part of the startup task of the target application through the main process, and starting a second user interface component through a child process of the main process, the second user interface component overlaying the first user interface component.

12. The electronic device of claim 11, wherein the start process of the first user interface component comprises: a creation stage corresponding to the first user interface component;
during the start process of the first user interface component, executing the second part of the startup task of the target application through the main process comprises: executing the second part of the startup task of the target application through the main process in the creation stage:
starting the second user interface component through the child process of the main process comprises: starting the second user interface component through the child process of the main process in the creation stage.

13. The electronic device of claim 11, wherein the second user interface component is configured to be in a transparent state.

14. The electronic device of claim 11, wherein the method further comprising: responding to a user input event through the second user interface component.

15. The electronic device of claim 14, wherein the user input event comprises one or more of: a touch event or a click event.

16. The electronic device of claim 11, wherein the method further comprising: after the start process of the first user interface component is completed, destroying the second user interface component.

17. The electronic device of claim 16, wherein destroying the second user interface component is by way of:
after the start process is completed, sending, by the first user interface component to the second user interface component, a first message indicating that the start process of the first user interface component is completed:
after receiving the first message, triggering, by the second user interface component, the destruction process of the second user interface component by invoking a predetermined destruction method.

18. The electronic device of claim 17, wherein the method further comprising:
before triggering the destruction process of the second user interface component by invoking the predetermined destruction method, sending, by the second user interface component to the first user interface component, user input information received by the second user interface component.

19. The electronic device of claim 11, wherein the first part of the startup task comprises initialization of the execution code comprised in the target application.

20. A non-transitory computer-readable storage medium having stored thereon a computer program, which when executed by a computer, causes the computer to perform a method for starting a user interface component, comprising:
executing a first part of a startup task of a target application in response to a start of the target application, and starting a first user interface component through a main process corresponding to the target application after execution of the first part is completed:
during a start process of the first user interface component, executing a second part of the startup task of the target application through the main process, and starting a second user interface component through a child process of the main process, the second user interface component overlaying the first user interface component.
